(19) United States
(12) Patent Application Publication
(10) Pub. No.: US 2022/0354195 A1
(43) Pub. Date: Nov. 10, 2022

(54) CUSTOMIZABLE KNEE PADS AND PROCESS OF FORMING THE SAME

(71) Applicants: Michael H. Panosian, Irvine, CA (US); Joshua M. Keeler, Irvine, CA (US)

(72) Inventors: Michael H. Panosian, Irvine, CA (US); Joshua M. Keeler, Irvine, CA (US)

(21) Appl. No.: 17/308,043

(22) Filed: May 4, 2021

(51) Int. Cl. A41D 13/06; B29C 45/14; B29C 45/00; A63B 71/12

(52) U.S. Cl. CPC A41D 13/065; B29C 45/14778; B29C 45/0001; A63B 71/1225; B29L 2031/4842

(57) ABSTRACT

An article of manufacture and a method are disclosed including a multi-layered knee pad including an outer shell and other layers forming high sidewalls, the height of which depends on the internal width of the knee pad. The outer shell may also have an array of recesses on its outer convex surface. The other knee pad layers include one or more foam layers on the concave side of the outer shell, one or more gel layers surrounded by the foam layers, and a fabric sheet covering the foam layers on the concave side of the outer shell. The knee pad is manufactured using an injection mold to form the foam layers. The knee pad is customizable with respect to size, firmness, and structure. The knee pad may be customized by varying the layer's characteristics such as material and dimensions as well as the size and location of the recesses.

### CROSS-REFERENCE(S) TO RELATED APPLICATION(S)

The present application is a Continuation-In-Part (CIP) of, and claims the benefit of the filing date of U.S. application Ser. No. 16/916,891, filed on 30 Jun. 2020, entitled “CUSTOMIZABLE KNEE PADS AND PROCESS OF FORMING THE SAME,” the contents of which are hereby expressly incorporated by reference in their entirety, under 35 U.S.C. § 120.

### TECHNICAL FIELD

The present disclosure generally relates to protective clothing and devices and, more specifically, to customizable knee pads and the process of forming the same.

### BRIEF DESCRIPTION OF THE DRAWINGS

The drawings, when considered in connection with the following description, are presented for the purpose of facilitating an understanding of the subject matter sought to be protected. In the figures referenced below, identical or similar parts shown are designated by the same reference numerals throughout.

FIG. 1 shows an example perspective view of a knee pad in accordance with the disclosure;

FIG. 2 shows an example rear perspective view of the knee pad of FIG. 1;

FIG. 3 shows an example cross-sectional view of the knee pad of FIG. 1;

FIG. 4 shows an example modified array of recesses having different sizes and spacings from the ones shown in FIG. 3;

FIG. 5 shows an example cross-sectional view of a mold used to form the knee pad of FIG. 1;

FIG. 6 shows a posterior or inside fabric sheet supported at ends of the mold of FIG. 5 and a gel pad or insert supported in close proximity behind the fabric sheet;

FIG. 7 shows the example mold of FIG. 5 and the knee pad of FIG. 1 after foam material has been injected to contact and/or encapsulate the gel insert and fabric sheet thereby bonding the knee pad with the fabric sheet and gel insert;

FIG. 8 shows an example cross-section of the knee pad of FIG. 1 with dimensions and proportions of the knee pad;

FIG. 9A shows an example cross-section of the knee pad of FIG. 1 with low sidewalls enclosing a knee;

FIG. 9B shows an example cross-section of the knee pad of FIG. 1 with high sidewalls enclosing a knee; and

FIG. 10 is an example flow diagram of the method of manufacturing the knee pad of FIG. 1.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references particular shape and cross section of the kneepad and material used in its construction, it will be appreciated that the disclosure may be used with other types of knee pad cross sections and materials, such as a non-curved cross section and memory foams.

Briefly described, an article of manufacture and a method are disclosed including a knee pad configuration, which may have various components and/or layers that when combined, form the knee pad. These layers and components may include an outer shell that forms a main body of the knee pad that serves as a knee cup to receive a user's knee. The outer shell and some other layers may extend further on the sides of the knee pad to form high sidewalls, the height of which depends on the internal width of the knee pad. The outer shell may also have an array of recesses on its outer convex surface. The knee pad further has one or more foam layers on the concave side of the outer shell (closer to the user's knee), one or more gel pads or layers enclosed or surrounded by the foam layers, and a fabric sheet covering the foam layers on the concave side of the outer shell, closest to the user's knee. The manufacturing methods may include an injection mold that allow injection of the foam layers. The knee pad is customizable with respect to size, firmness, and structure. A desired level of firmness on a scale that may go from a soft level to a hard level, depending on the use or application, may be built at manufacturing time. The knee pad may be customized by varying the layer's characteristics such as material and dimensions as well as the size and location of the recesses.

A knee pad insert is disclosed including an injection foam layer having a knee support section and two sidewalls, together forming a knee cup with a width. A gel pad is also included that is at least partially enclosed by the injection foam layer. Also included is a fabric sheet extending between the sidewalls and covering both the injection foam layer and the gel pad. The height of the sidewalls depends on the width of the knee cup.

A knee pad is disclosed including an outer shell having a concave inner surface, a convex outer surface, and an area. An injection foam layer is coupled with the concave inner surface of the outer shell, the injection foam layer having two sidewalls. A gel pad at least partially extending across the area of the outer shell is also included. The height of the sidewalls is related to an internal width of the knee pad.

A method of making a knee pad is disclosed including selecting an outer shell for the knee pad to receive a molded insert, preparing a mold to construct the molded insert, the mold having an internal space, an injection channel, and a support member. The method further includes placing a gel pad within the internal space, injecting foam material through the injection channel into the internal space to form the molded insert, and integrating the molded insert with the selected outer shell.

Manufacturers offer numerous knee pads that are intended for different activities, for example, for sports and extreme sports, for dancing and acrobatics, for working and military purposes, and the like. In addition, most or all of these knee pads are sometimes adapted for more specific purposes. For example, every knee pad has to be not only protective, but also comfortable, flexible, lightweight, breathable, easy to use and wash, stylish, high-quality, affordable, and have other similar desirable features and characteristics. In short, the needs and wants of consumers and professionals are only increasing, therefore manufacturers constantly have to develop and innovate new features and designs for their products.

A function of knee pads is knee protection against different knee injuries that are usually caused by blows, attrition, pressure and other outer impacts during kneeling and other physical activities that involve external forces and pressures being exerted against the knee. However, the protection of knee is not the only required feature of knee pads. Manufacturers often have to devise methods and approaches to combine such protection with other desirable features and design constraints. One such approach is the use of different materials, which could provide multiple features simultaneously, including protection, comfort, flexibility, likable and modern design, quality and affordability, among others. Design constraints include ease of manufacturing, cost, use of non-hazardous material, marketability, and the like, which are not directly related to the design but affect the success of the final product based on the design.

A common component of a knee pad is padding or cushioning that is usually placed on the kneecap and prevents or reduces knee injuries. The padding can be made of various materials, for example, polyurethane foam, polyethylene foam, ethyl vinyl acetate foam, nylon foam, neoprene foam, polyvinyl chloride foam, extruded polystyrene foam, memory foam, rubber, plastic, gel, carbon fiber, and other suitable and supple materials.

Knee pad cushioning is provided by different approaches. Some of the knee pads may have a shell or cap type padding that is usually is made of plastic, rubber, gel, carbon fiber or other durable and high density material which can ensure constant protection. The inside of these shells is usually covered by a softer and more elastic material to provide a better conformation to the shape of the kneecap and thus comfort. Some knee pads have padding which is made of soft, but durable and protective material such as foam—PU foam, PE foam, EVA foam, PVC foam, XPS foam, nylon foam and neoprene foam. Many knee pads have hex-pad padding which is made of dozens of separate hexagon type pads, hence, usually providing better conformation to the shape of the knee and thus comfort and flexibility during use. These hexagon type pads usually are made of some type of foam which is able to absorb the shock of different blows. Hexagon type pads often are called as honeycomb type pads because of their similarity. Some of knee pads have bubble type cushioning which also is made of some foam to protect the knee against different impacts.

Knee pads can be categorized by their usage in different niches, for example, sports knee pads, dance knee pads, work knee pads, military knee pads and others. These knee pads differ from each other with functionality and level of protection. For example, knee pads for sports and dancing are more comfortable and flexible, but knee pads for working and military are thicker, denser and more durable.

Working knee pads, especially for the professional trades may not be so flexible, but they have to be extremely durable and comfortable, because in such works as carpeting, concrete forming, tiling, flooring, gardening and construction workers have to spend a significant amount of time on their knees. Therefore, the padding has to be comfortable for long hours of work, thereby reducing the pressure on knees and thus knee pain and fatigue. Working knee pads for professional construction workers or other similar trades are mostly used for preventing of occupational knee injuries. There are a number of working knee pads on the market, for example, hard-cap, curved soft cap, flat-cap knee pads, kneeling pads, rolling knee pads, knee inserts, and the like, each of which is designed for certain and specific purposes.

Military or tactical knee pads may be part of the uniform for some military personnel and are made of extremely durable and dense bulletproof material, making them safe in almost every situation. Such knee pads are meant not only for safety against bullets or other dangerous impacts, but also for knee protection against bruises or abrasions caused by crawling or squatting during warfare or other training exercises.

U.S. Pat. No. 7,018,351 discloses an orthopedic support using a molded pad and a rigid shell. The internal structure is molded to include the geometrically shaped cells of various sizes, shapes and thickness to provide different levels of localized comfort to the user. The pad is made from a thermoplastic elastomer (TPE) that is spring-like and resists compression sets. The TPE material is injection molded to include detailed designs such as geometrically shaped cells. Soft foam can be embedded between the rigid cells in the padding. As another option, gel is used in place of the soft foam. However, the level of desired cushioning is provided by utilizing multiply sized cells, rods and various protrusions. As an alternate to the use of variously shaped cells and protrusions a softer foam may be embedded between rigid cell walls. Typically, the over mold that seals the TPE pad to the shell is made of the same material as the padding and also partially covers the shell. Another option is to use gel in place of the soft foam or the molded TPE pad.

While numerous knee pad designs have been proposed they have not been readily customizable and have typically required intricate and expensive molds and processes for manufacturing the products to adapt them for specific applications.

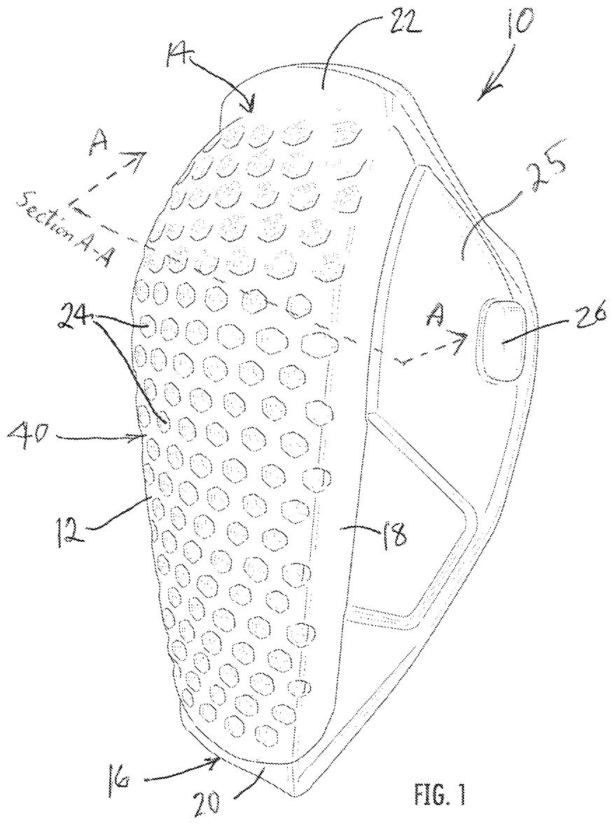

FIG. 1 shows an example perspective view of a knee pad in accordance with the disclosure. In various embodiments, knee pad 10 includes an anterior or external surface 12, a knee pad top end 14, a knee pad bottom end 16, a knee pad bottom extension 20, a knee pad top extension 22, recesses 24 arranged in an array, lateral sides 18, sidewalls 25, and strapping ears 26.

In various embodiments, main body 40 has lateral sides 18 further extending to become sidewalls 25. The main body 40 further has top extension 20 and bottom extension 22. This configuration of the knee pad forms a knee cup with a concave surface facing a user's knee and a concave surface facing away from the user's knee, when the knee pad is worn by the user. While the anterior surface 12 is shown to extend between bottom and top extensions 20, 22, respectively, the effective anterior surface can be modified to render it more centralized over the knee cap short of the extensions 20, 22.

In various embodiments, the knee pad may have various components and/or layers that when combined, form the knee pad. These layers and components may include an outer semi-hard shell that forms the main body 40 with the array of recesses 25, a molded fabric laminated with ethyl vinyl acetate (EVA) layer, one or more foam layers on the concave side of the main body 40 (closer to the user's knee), one or more gel pads enclosed or surrounded by the foam layer, and a fabric sheet covering the foam layer on the concave side of the main body 40, closest to the user's knee.

In various embodiments, the manufacturing process for making the knee pad may entail using a mold for injection of foam that can over-mold a gel insert or gel pad that becomes integrated with the foam, thereby simplifying the molding process and preventing shifting of the gel insert over time. A soft fabric backing sheet may also be integrated with the molded foam to facilitate manufacturing and prevent separation of the fabric sheet from the foam after extended use.

In various embodiments, the knee pad may be customized based on one or more of its components or characteristics. More specifically, the knee pad may be customized at manufacturing time by using different outer shells with different levels of hardness and rigidity, by using different types of foams and gels with different characteristics and flexibility properties, by using different types and colors of fabrics, and the like. The springiness, elasticity, suppleness, firmness and other such elastic properties of various layers, or a combination thereof, may be used to provide a desired level of firmness on a calibrated firmness scale that may go from a soft level to a hard level, depending the use or application. Such firmness scale may be applied to individual layers or combinations thereof.

In various embodiments, the customizable knee pad may further include the anterior or exterior surface 12 having a surface area A, and the posterior surface molded to the shape of the knee, defined by the contours of the main body. The anterior surface 12 may be formed with the array of spaced recesses 24 over a predetermined region covering the knee to be protected. Each recess 24 defines an incremental area, and said recesses over a predetermined region collectively or cumulatively define an area Aᵣ. The effective area A_{eff} of the anterior surface that is not recessed is approximately defined by A_{eff}=A−Aᵣ. It is clear that the effective surface area A_{eff} decreases as the cumulative area Aᵣ of the recesses 24 increases. A fabric sheet covers the rear or posterior surface as will be more fully described with respect to figures below. A gel pad may be deployed within the main body in proximity to the fabric sheet.

The main body of the knee pad is injection molded with the gel layer and fabric sheet in place during the molding process to bond the fabric sheet and gel pad to the molded main body to be integrally formed therewith. Since the force required to deform a solid is directly proportional to the effective surface area that is deformed in compression at least in the linear region of the material that follows Hooks Law by selectively modifying the effective surface area in the predetermined region can alter the flexibility of the material in compression and, therefore, render the material harder or softer.

The method of forming a knee pad in accordance with the invention includes the steps of providing a mold configured to impart to an interior surface of any paired with an array of recesses over the predetermined region for protection of the knee pad, the density and sizes of the resulting recesses determining the affected area for compression. A gel insert is supported within the mold and the mold is covered with a fabric sheet or layer in close proximity to the supported gel insert. A spray foam is then injected into the mold until the mold is filled with foam to encapsulate the gel insert and contact the fabric sheet so that the foam bonds to the gel insert and the fabric sheet. The cumulative incremental areas of the resulting recesses on the interior surface of the resulting knee pad main body in the separation of the recesses is selected to provide knee pads that have normal or medium hardness, knee pads that are softer or harder for the same or like density foam materials.

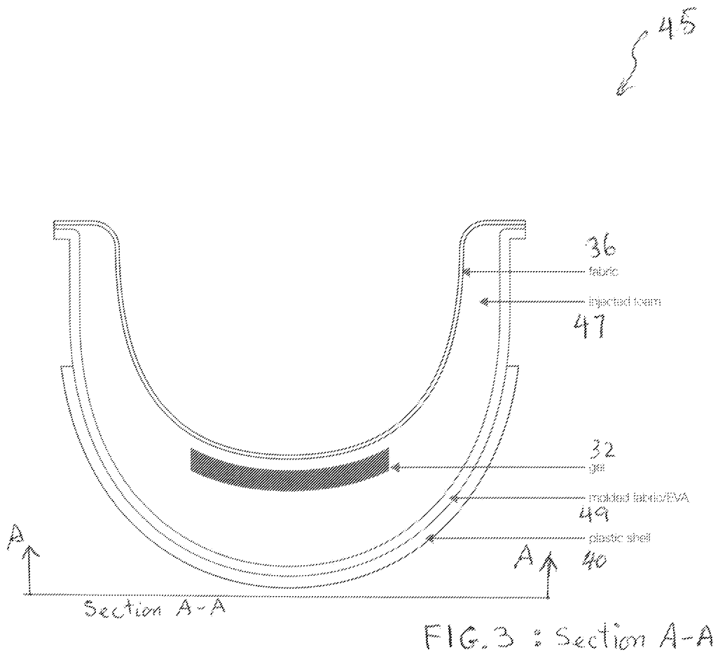

The various layers making up the knee pad as described above, will be described in more detail with respect to cross section A-A of the drawing shown in FIG. 1 and detailed in FIG. 3.

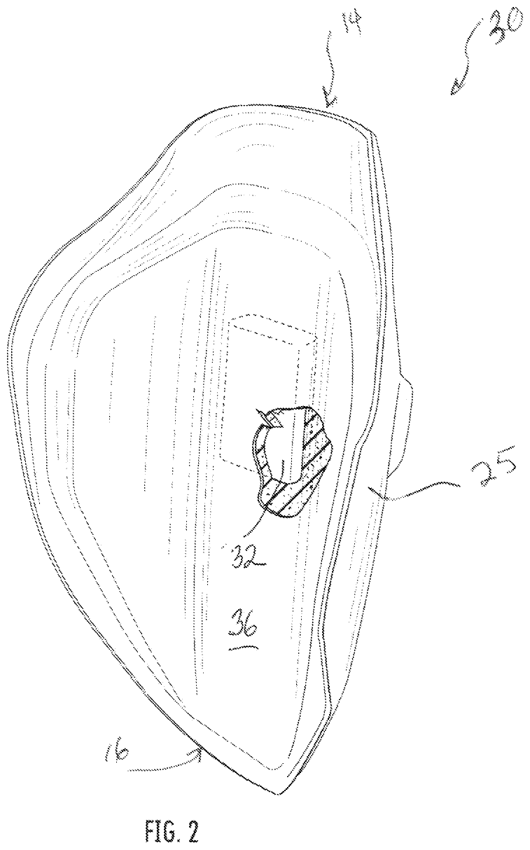

FIG. 2 shows an example rear perspective view of the knee pad of FIG. 1. In various embodiment the rear perspective view 30 of the knee pad 10 includes the top end 14, the bottom end 16, a fabric sheet 36, a gel pad or insert 32, and sidewalls 25.

In various embodiments, the gel pad 32 is embedded in the foam insert within the outer shell 40 (or main body) to further cushion the user's knee against pressure and bruising. The fabric sheet 36 may be made of polyester, nylon, cotton, or other durable synthetic or natural materials or a combination thereof. The fabric sheet 36 may serve to reduce friction and abrasion on the user's knee or clothes, and generally feel more comfortable than without having such fabric sheet.

In various embodiments, the gel insert 32 may be a pad that is smaller than a width, the length, and/or entire inside area of the knee pad 10. In other embodiments, the gel insert 32 may cover the entire inside area of knee pad 10. In some embodiments, the gel pad 32 may extend to cover the inside surfaces of the sidewalls 25, while in other embodiments, the gel pad 32 may be limited to covering a portion or all of the knee pad 10′s inner surface excluding the inner areas of the sidewalls 25. The thickness of the gel pad 32 may be between 3-8 mm, or less or more, depending on the flexibility or elasticity of the gel material. In some embodiments, the gel insert may be completely enclosed within one layer of foam or be sandwiched between two or more layers of foam. In other embodiments, the gel pad may be covered on its outer face (facing away from the user's knee) by the foam layer, and on its inner face (facing the user's knee) be in direct contact with the user's knee or be directly touching the fabric sheet 36 without a foam layer between the gel pad 32 and fabric sheet 36. In the latter case, the user's knee is in contact with the fabric sheet 36 and coupled with the gel pad 32 via the fabric sheet 36.

FIG. 3 shows an example cross-sectional view of the knee pad of FIG. 1. In various embodiments, the cross section 45 of knee pad 10 is a cross-sectional view A-A shown in FIG. 1, having several distinct layers. The layers forming the knee pad 10 include the fabric sheet 36, an injected foam layer 47, the gel pad 32, a molded fabric lamination 49, and the outer shell 40.

In various embodiments, one or more of each of the above layers may be included in the construction of the knee pad 10. In some embodiments some of these layers may not be included. The outer shell 40 may be made of hard or semi-hard plastic, nylon, rubber, gel, carbon fiber or other durable and high-density material that can protect user's knee against impact and pressure loads. The outer shell may further be partially covered with recesses 24, that help spread pressure by spreading out and increase friction between the knee pad 10 outer surface that is in contact with ground or floor when kneeling. Each layer of the knee pad 10 has an inner surface facing the user's knee and an outer surface facing away from the user's knee. Generally, the inner surfaces of these layers are concave and the outer surfaces are convex.

In various embodiments, the molded fabric lamination 49 is integrated with the outer shell 40 to maintain the shape of knee pad 10 and provide more elasticity than the outer shell 40. This layer may perform a transitional function, in terms of elasticity and softness, between the harder outer shell 40 and the softer injection foam layer 47. Those skilled in the art will appreciate that hardness and softness in this context is relative and comparative between different layers. In some embodiments, the molded fabric lamination 49 may be laminated with EVA or other suitable material that can be used in such lamination.

In various embodiments, injected foam layer 47 may be made of a softer and more elastic material to provide better conformation to the shape of the user's kneecap and thus provide more comfort. The injected foam layer 47 may be made of foam material such as polyurethane (PU) foam, polyethylene (PE) foam, EVA foam, polyvinyl chloride (PVC) foam, polystyrene (XPS) foam, nylon foam, neoprene foam, and other similar foams. In some embodiments, the injected foam layer 47 may be supplemented with an additional foam layer, which may be made of hex-pad, which may have a honeycomb structure with multiple (on the order of dozens) of separate hexagon type pads that usually providing better and finer-grain conformation to the shape of the user's knee and better comfort during use.

In various embodiments, the injected foam layer 47 has a simple structure that includes a knee support section that extends approximately the whole internal width of the knee pad 10 that receives the user's frontal knee surface and bears the weight of the user when kneeling. The knee support section is shown in FIG. 3 as the thicker horizontal portion of the injected foam layer 47. The injected foam layer 47 also has sidewalls 25 that are extensions of the knee support section and extend the knee support section upwards (with respect to section A-A) to cover the sides of the user's knee. The sidewalls 25 are relatively thinner than the knee support section. The knee support section and the sidewalls 25 form a curved cup-shaped knee cup to receive the user's knee.

In various embodiments, the gel insert 32 may cover a portion less than the entire inside area of the knee pad 10. In other embodiments, the gel insert 32 may cover the entire inside area of knee pad 10. In some embodiments, the gel pad 32 may extend to cover the inside surfaces of the sidewalls 25, while in other embodiments, the gel pad 32 may be limited to covering a portion of the knee pad 10's inner surface excluding the inner areas of the sidewalls 25. In some embodiments, the gel insert may be completely enclosed within one layer of foam or it may be sandwiched between two or more layers of foam. In other embodiments, the gel pad may be covered on its outer face by the foam layer, and on its inner face be in direct contact with the user's knee, or be directly covered by the fabric sheet 36 without a foam layer between them.

In various embodiments, the fabric sheet 36 may be made of polyester, nylon, cotton, or other durable synthetic or natural materials or a combination thereof. The fabric sheet 36 may serve to reduce friction and abrasion on the user's knee or clothes, and generally feel more comfortable than without having such fabric sheet.

In various embodiments, the two outer layers, namely, the outer shell 40 and the molded fabric lamination 49 are manufactured separately from the other layers, which form the knee pad molded insert. The knee pad insert is integrated to include the fabric sheet 36, the injected foam 47, and the gel pad 32. Once the outer layers and the knee pad molded insert are manufactured, the knee pad molded insert is further integrated with the outer layers to form the completed knee pad. After the manufacturing of the outer shell and the molded insert, they are integrated together using glue, stitching, rivets, or other similar methods, to create the knee pad 10.

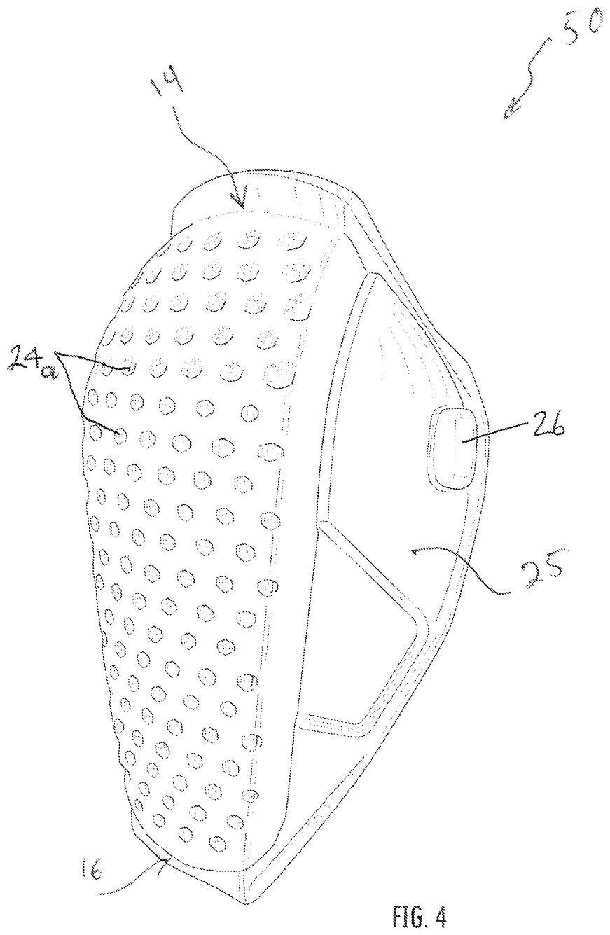

FIG. 4 shows an example modified array of recesses having different sizes and spacings from the ones shown in FIG. 3. In various embodiments, the knee pad perspective view 50 includes the top end 14, the bottom end 16, the sidewalls 25, the strapping ears 26, and variable size recesses 24a.

In various embodiments, an alternate array of recesses is an array of variable size recesses 24a, which are smaller than those shown in FIG. 1, and the spacing between the recesses within the array may also be smaller. Using the variable size recesses 24a may affect the stiffness of the knee pad. As such, selecting the sizes and shapes of the recesses 24a, as well as their spacing within the array can produce a knee pad for various applications, such as a medium stiffness for normal use, or a softer or a harder knee pad using the same or similar foam material depending on the application of the knee pad. The same manufacturing process may be employed to use the same or slightly modified molds with an insert to reflect the size, shape and spacing of the recesses within the array.

In various embodiments, the specific cross-sectional shape of the recesses 24a may vary and include circles, squares, hexagons triangles, or other suitable shapes. The cumulative area of the recesses 24a can also be modified by changing not only the shapes and sizes of the recesses but the spacing of the recesses in the array.

In various embodiments, the knee pad 10 may be formed without the recesses 24 or 24a. The knee pad 10 may still benefit from the unitary or integrated bonding of the gel insert 32 and fabric sheet 36 to the injected foam 47 and outer shell or main body 40, and resist separation of the gel insert 32 and/or fabric sheet 36 from the main body 40 with extended use.

In various embodiments, the lateral sides 18 (see FIG. 1) extend to each side of the kneepad and provide lateral protection to the knee as well as provides rigidity to the main body of the resulting knee pad 10 and preventing deformation during use. The top and bottom extensions 20, 22 also help to rigidify the structure and these are not within the protective region of the knee pad that can be adjusted or modified in terms of hardness and softness to further customize the knee pad 10. The lateral sides 18 also include strapping ears 26 used to attach a strap for securing the knee pad to the leg of the user. Any conventional straps, including elastic straps, may be used.

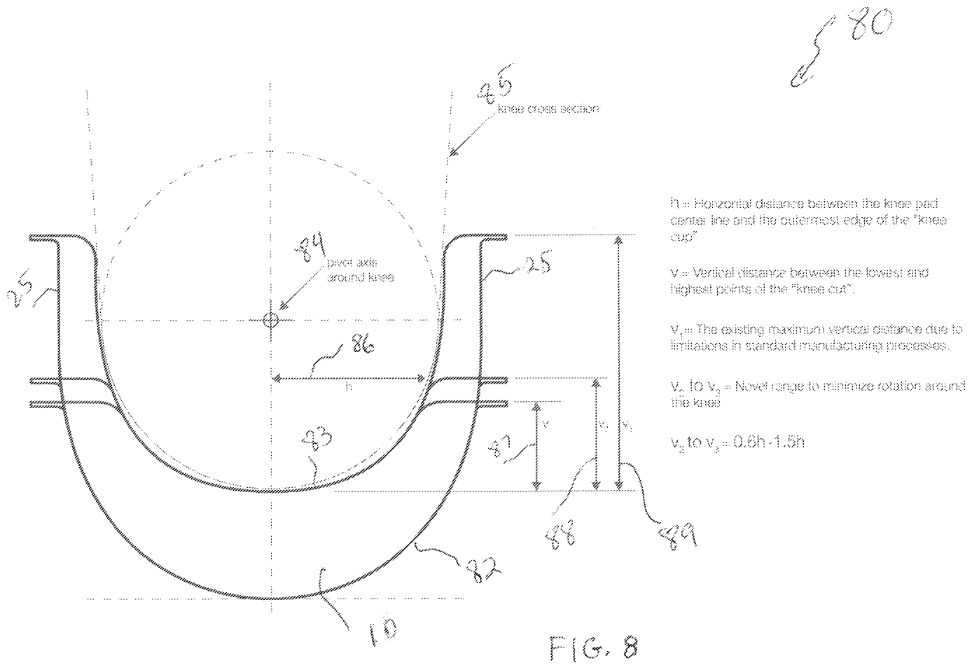

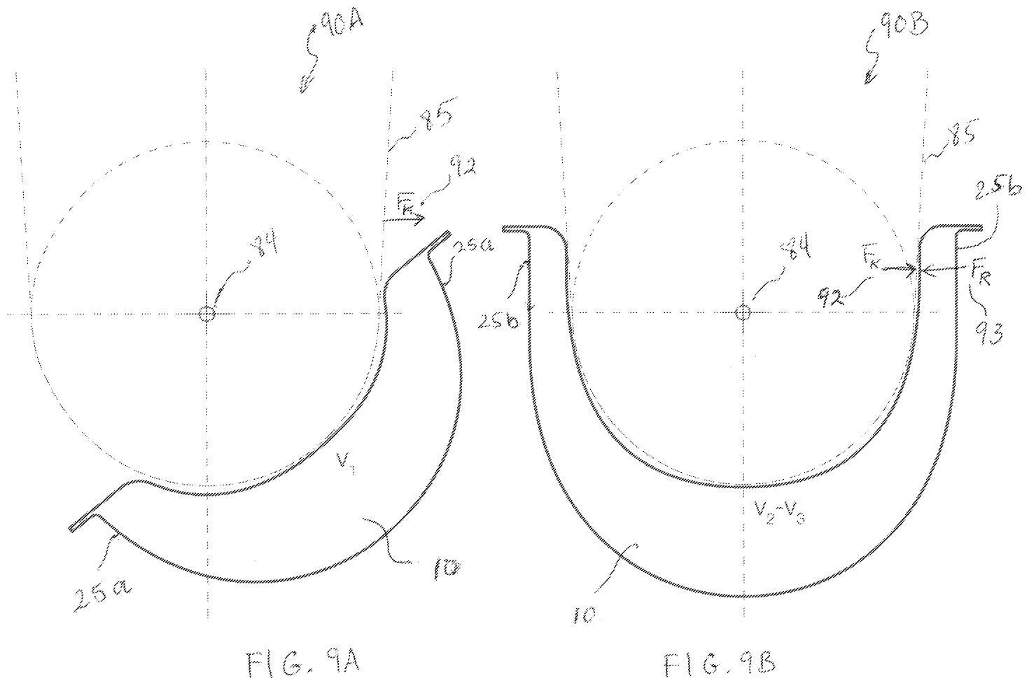

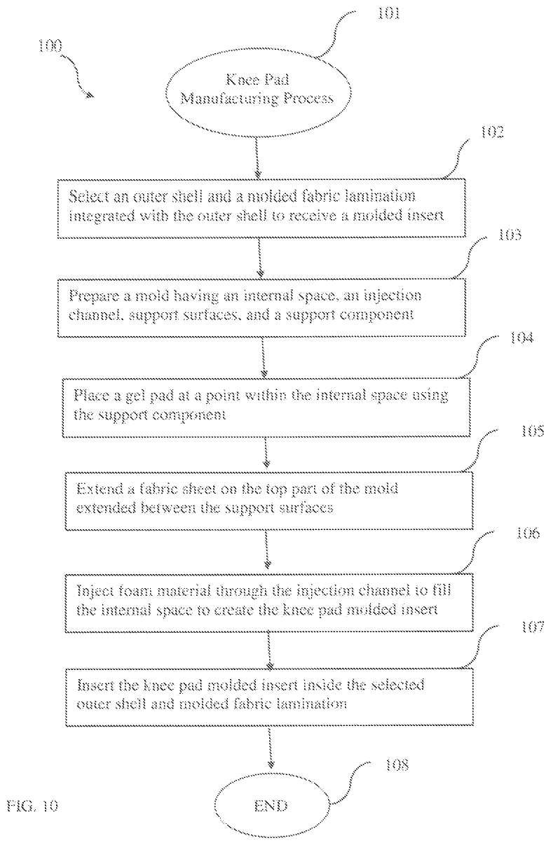

In various embodiments, the lateral sides 18 may extend to form sidewalls 25 to further maintain the shape of the knee pad 10 and also prevent or reduce lateral slippage of the knee pad 10 around the user's knee during use and physical activities. Generally, lower sidewalls allow slippage and/or rotation of the knee pad 10 on or around the user's knee more easily than higher sidewalls in comparison, as further described below with respect to FIGS. 8 and 9.

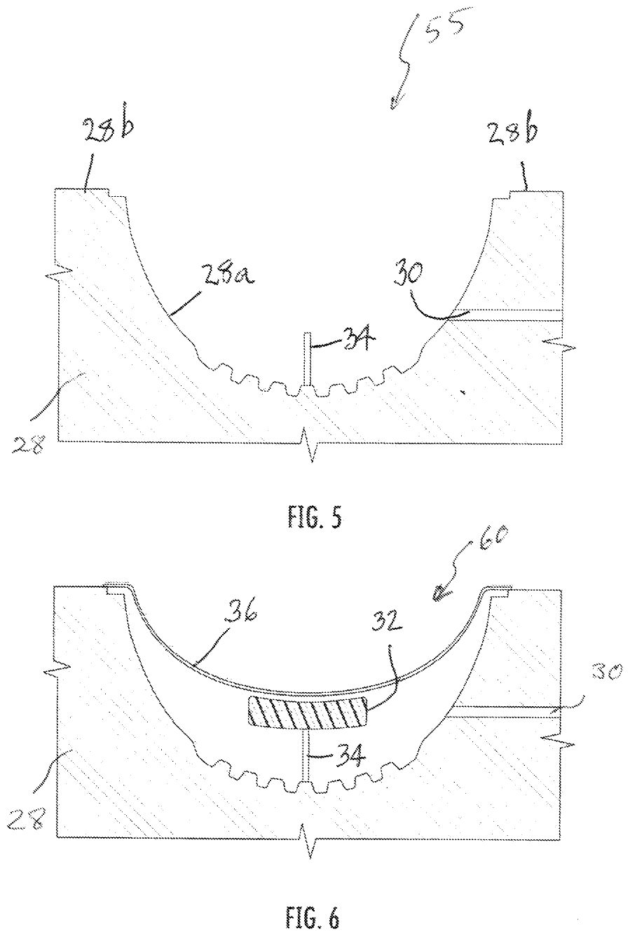

FIG. 5 shows an example cross-sectional view of a mold used to form the knee pad of FIG. 1. In various embodiments, the cross-sectional view 55 includes a mold 28, internal mold surface 28a, mold support surfaces 28b, gel support member 34, and foam injection channel 30.

In various embodiments, an example process of making the knee pad is illustrated with respect to this figure. The internal surface 28a of the mold 28 is designed to conform to the outer or anterior surface 12 of knee pad 10 (see FIG. 1). At the top of mold 28 and to each side of the internal surface 28a are support or bearing surfaces 28b. The foam injection channel 30 is used to inject the foam material to form the knee pad 10.

In various embodiments, the mold 28 may have different internal volumes and corresponding injection channels (not shown) that may be used to form separate foam layers. In these embodiments, the gel pad 32 is surrounded by two separate layers of foam rather than be enclosed in one layer of foam. In other embodiments, a second layer of foam may be separately manufactured and separately (from this molding process) bonded on top of the foam layer 47 and gel pad 32. This process allows the gel pad 32 to be sandwiched between two or more foam layers.

As noted above with respect to FIG. 3, the mold 28 is used to manufacture the knee pad molded insert, which is later inserted into the outer layers, including the outer shell 40.

In various embodiments, the gel support member 34 is used to hold a gel pad 32 in place while the foam is being injected. When the foam hardens in the mold, the gel pad 32 is enclosed within the foam 47 (see FIG. 3). The usage of mold 28 is further described below with respect to FIG. 6.

FIG. 6 shows a posterior or inside fabric sheet supported at ends of the mold of FIG. 5 and a gel pad or insert supported in close proximity behind the fabric sheet. In various embodiments, the mold first manufacturing state 60 shows the mold 28, foam injection channel 30, the gel support member 34, the gel pad 32, and the fabric sheet 36.

In various embodiments, gel pad 32 is supported and held above the surface 28a by the support member 34. The fabric sheet 36 extends across the internal mold surface 28a and supported by the support or bearing surfaces 28b. The fabric layer 36 is conformed to the desired shape of knee pad 10 to generally correspond to the shape and size of the user's knee. The support member 34 is selected to position the gel pad 32 in close proximity to the fabric sheet. In some embodiments, the gel pad 32 may be in direct contact with the fabric sheet 36, while in other embodiments, a layer of foam may be between the gel pad 32 and the fabric sheet 36.

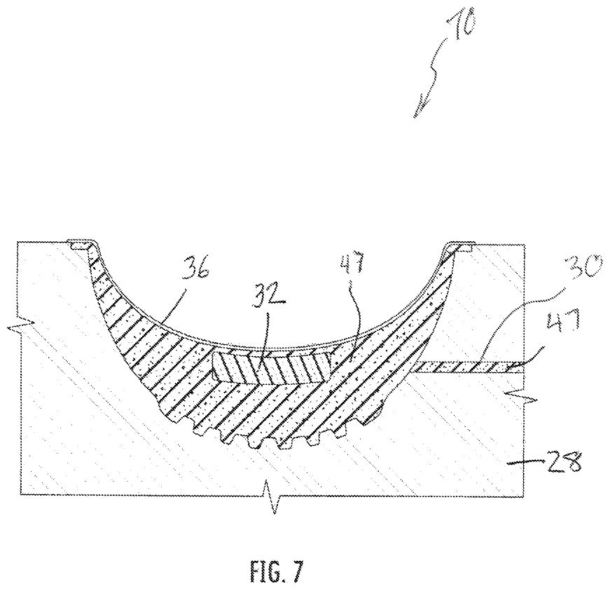

At the state of the manufacturing shown, the gel pad 32 has been placed in the mold and the fabric sheet 36 is also extended across the mold to be integrated with the foam. At this stage, the foam 47 has not yet been injected in the mold from injection channel 30. This process is further described below with respect to FIG. 7.

FIG. 7 shows the example mold of FIG. 5 and the knee pad of FIG. 1 after foam material has been injected to contact and/or encapsulate the gel insert and fabric sheet thereby bonding the knee pad with the fabric sheet and gel insert. In various embodiments, the mold second manufacturing state 70 shows the mold 28, foam injection channel 30, the gel support member 34, the gel pad 32, the fabric sheet 36, and the injected foam 47.

In various embodiments, the foam 47 is injected through the foam injection channel 30 to fill the entire internal volume of the mold 28 as defined by the space between the mold surface 28a and the fabric sheet 36. Depending on the placement of the gel pad within the mold 28 volume, the gel pad 32 may fully encapsulate the gel pad 32 and touch the inner of the fabric sheet 36 surface (fabric surface facing internal mold surface 28a), or it may not encapsulate it on the side of the gel pad facing the fabric sheet 36. As the foam 47 sets and bonds to both the gel pad 32 and/or the fabric sheet 36, these layers are permanently bonded together. Such bond is generally permanent and strong and resists separation of the fabric sheet 36 from the main body 40 and other layers. Generally, this bond is stronger than a bond provided by an applied adhesive. Also, because of the strong bond between the main body and the gel pad 32, this process prevents or reduces the shifting of the gel pad with extended use. This is different from most knee pads that employ a gel insert placed within a surface recess after the main body 40 has been molded.

FIG. 8 shows an example cross-section of the knee pad of FIG. 1 with dimensions and proportions of the knee pad. In various embodiments, the cross section 80 includes knee pad 10, sidewalls 25, knee pad external surface 82, knee pad internal surface 83, user's knee pivot point 84, user's knee cross section 85, horizontal distance 86 (h) between centerline of the knee pad to the internal surface of the sidewalls 25, internal vertical height of conventional knee pads 87 (V1), minimum internal height of knee pad 88 (V2), and maximum internal height of knee pad 89 (V3).

In the context of FIG. 8, the directions mentioned, including “vertical” and “horizontal” are defined with respect to the structure of the knee pad 10 itself. The vertical direction is defined as the direction of the centerline passing through the symmetrical closed bottom of the knee pad 10, and the geometric center (close to the knee pivot point 84) of the knee pad 10. This centerline defines the vertical direction for knee pad 10, even if it is not aligned with the gravitational vertical direction (direction of Earth's gravitational force). The horizonal direction for the knee pad 10 is defined as the direction that is perpendicular to the vertical direction. Similarly, terms such as “low”, “lower”, “lowest”, “high”, “higher”, “highest”, “height”, “bottom”, “top”, “up”, and “upper” are defined with reference to the vertical direction as used in this specification, with low or bottom being the closed end of the knee pad 10 where the user's knee touches, and high or top being the open end of the knee pad 10 where the sidewalls 25 end.

The cross section 80 shows a simplified cross section of the whole knee pad 10 without showing all the layers and components. It is intended to show the contours of the knee pad excluding all the details depicted in other figures referenced herein for clarity.

In various embodiments, the height of the sidewalls 25 may be manufactured to range from the minimum internal height 88 (V2) to the maximum internal height 89 (V3). Both V2 and V3 dimensions are measured from the lowest point of the knee pad internal surface 83 to the highest point of the sidewalls 25, as shown. Additionally, the range of the height of sidewalls 25 may be related to the horizontal distance 86 (h) as: range=0.6 h to 1.5 h. For example, if h is 2 inches, then the sidewall height may range from 1.2 inches as a minimum, to 3 inches as a maximum. The horizontal distance 86 is approximately half the internal width (fitting on user's knee from one side of the knee to the other, and not from front of the knee to its back) of the knee pad, or the knee cup formed by the injected foam layer 47.

The manufacturing of sidewalls 25 with different heights may require different molds or modified molds based on application, product cost/price, manufacturing capabilities, and other factors. Higher sidewalls, generally allow the knee pad 10 to be more stable and stay centered on the user's knee during use, compared with lower sidewalls that may allow the knee pad to shift around as the user moves or drags his knee on the ground or floor. This is described further below with respect to FIGS. 9A and 9B.

FIG. 9A shows an example cross-section of the knee pad of FIG. 1 with low sidewalls enclosing a knee. In various embodiments, cross section 90A includes knee pad 10, low sidewalls 25a, knee pad external surface 82, knee pad internal surface 83, user's knee pivot point 84, user's knee cross section 85, and a knee force 92 (F_{K}) exerted by user's knee.

In various embodiments, the relatively low sidewalls (compared with a higher sidewall) partially encloses the user's knee, as depicted by dotted lines in FIG. 9A. The user's knee exerts a knee force 92 against the low sidewalls 25a. Frictional forces between the external surface 82 (see FIG. 8) of the knee pad 10 and the ground can cause the knee pad 10 to shift and/or rotate around the user's knee. If the low sidewalls 25a are sufficiently high, then the user's knee force 92 will resist such rotation by the knee pad by countering it. But if the low sidewalls 25a are not high enough, the knee force 92 may not effectively push back on the low sidewalls 25a to prevent rotation or shifting of the knee pad 10 on user's knee. This situation is depicted as F_{K} not coinciding with or being applied to and not pushing against the low sidewall 25a, but being suspended in air.

FIG. 9B shows an example cross-section of the knee pad of FIG. 1 with high sidewalls enclosing a knee. cross section 90A includes knee pad 10, high sidewalls 25b, knee pad external surface 82, knee pad internal surface 83, user's knee pivot point 84, user's knee cross section 85, a knee force 92 (F_{K}) exerted by user's knee, a resistance force 93 (F_{R}).

In various embodiments, the relatively high sidewalls (compared with a lower sidewall) partially encloses the side of the user's knee, as depicted by dotted lines in FIG. 9B. The user's knee exerts a knee force 92 against the high sidewalls 25b. Frictional forces between the external surface 82 of the knee pad 10 and the ground can cause the knee pad 10 to shift and/or rotate around the user's knee. If the high sidewalls 25b are sufficiently high, then the user's knee force 92 will resist such rotation of the knee pad by countering the resistance force 93 (F_{R}) generated by frictional forces between the external surface 82 and the ground. This situation is depicted as F_{K} coinciding with and being applied to and pushing against the high sidewall 25b and resistance force F_{R}.

FIG. 10 is an example flow diagram of the method of manufacturing the knee pad of FIG. 1. In various embodiments, the flow diagram 100 starts at block 101 and proceeds to block 102.

At block 102, an outer shell 40 type or configuration is selected to receive a knee pad insert. The outer shell may have an inner layer (towards user's knee) made of a molded fabric lamination 49, as described above with respect to FIG. 3. The knee pad insert is attached to the outer shell using glue, stitching, rivets, or other attachment methods. Proceed to block 103.

At block 103, prepare a mold 28 for multi-layer molded knee pad insert. The mold has an internal space that is accessible via an injection channel 30 (see FIGS. 5-7) to inject foam material. It further includes a support member 34 and support surfaces 28b. Proceed to block 104.

At block 104, place a pre-made gel pad 32 in the mold space using the support member. The height of the support member 34 measured from the close end of the mold (see FIG. 5) may be approximately the same as the thickness of the injection foam layer, depending on mold configuration. In some embodiments, the height of the support member and thickness of the gel pad combined may be sufficient to touch the fabric sheet 36 without having a foam layer between the gel pad 32 and fabric sheet 36. In other embodiments, the height of the support member creates a gap between the gel pad 32 and fabric sheet 36 to be filled with the injection foam 47. Proceed to block 105.

At block 15, extend fabric sheet 36 across mold 28′s support surfaces 28b that also defines the interior surface of the knee pad 10 that touches the user's knee. The fabric sheet provides a software surface to be in contact with the user's knee. This layer is also the upper boundary of the injection foam layer. Proceed to block 106.

At block 106, inject the foam material through the injection channel 30 to form the injection foam layer 47. In some embodiments, the injected foam may completely surround and enclose the gel pad 32, while in other embodiments, the injected foam may cover the gel pad partially and allow the top of the gel pad 32 to touch the fabric sheet 36. Once cured, this step completes the construction of the knee pad molded insert. Proceed to block 107.

At Block 107, the knee pad molded insert is integrated with the selected outer shell 40 and molded fabric lamination 49 by glue, stitch, or rivet, or other similar techniques. Proceed to block 108.

At block 108, the process terminates.

It will be further understood that unless explicitly stated or specified, the steps described in a process are not ordered and may not necessarily be performed or occur in the order described or depicted. For example, a step A in a process described prior to a step B in the same process, may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” It is further understood that any phrase of the form “A/B” shall mean any one of “A”, “B”, “A or B”, or “A and B”. This construct includes the phrase “and/or” itself.

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

1. A knee pad insert comprising:
an injection foam layer having a knee support section and two sidewalls, together forming a knee cup, wherein the knee cup has a width;
a gel pad at least partially enclosed on one surface by the injection foam layer; and
a fabric sheet extending between the sidewalls and covering both the injection foam layer and the gel pad;
wherein a height of the sidewalls is a multiple of half of the width of the knee cup, half of the width of the knee cup being defined as a horizontal distance between a geometric center of the knee pad and an internal surface of the sidewalls.

2. The knee pad insert of claim 1, wherein the injection foam layer comprises one of polyurethane foam, polyethylene foam, ethyl vinyl acetate foam, nylon foam, neoprene foam, polyvinyl chloride foam, extruded polystyrene foam, memory foam, plastic, and carbon fiber.

3. The knee pad insert of claim 1, wherein the two sidewalls are thinner relative to the knee support section.

4. The knee pad insert of claim 1, wherein the gel pad is entirely enclosed within the injection foam layer.

5. The knee pad insert of claim 1, wherein the gel pad is partially surrounded by the injection foam layer and touches the fabric sheet on another surface of the gel pad.

6. The knee pad insert of claim 1, wherein the fabric sheet is permanently bonded with at least one of the injection foam layer and the gel pad.

7. The knee pad insert of claim 1, wherein a height of the sidewalls is at least approximately 0.6 multiplied by half of the width of the knee cup.

8. The knee pad insert of claim 1, wherein the wherein a height of the sidewalls is at most approximately 1.5 multiplied by half of the width of the knee cup.

9. A knee pad comprising:
an outer shell having a concave inner surface, a convex outer surface, and an area;
a knee pad insert integrated with the knee pad, the knee pad insert including:
an injection foam layer coupled with the concave inner surface of the outer shell, wherein the injection foam layer has two sidewalls; and
a gel pad at least partially extending across the area of the outer shell, wherein a height of the sidewalls is related to an internal width of the knee pad.

10. The knee pad of claim 9, further comprising a molded fabric lamination placed between outer shell and the injection foam layer.

11. The knee pad of claim 9, further comprising a fabric sheet is bonded to at least one of the injection foam layer and the gel pad.

12. The knee pad of claim 9, wherein the outer shell has an array of recesses on its convex outer surface.

13. The knee pad of claim 12, wherein recesses in the array of recesses have various sizes.

14. The knee pad of claim 9, wherein a minimum height of the sidewalls is approximately equal to 0.6 multiplied by half of the width of the concave inner surface of the knee pad and a maximum height of the sidewalls is approximately equal to 1.5 multiplied by half of the width of the concave inner surface of the knee pad.

15. A method of making a knee pad, the method comprising:
selecting an outer shell for the knee pad to receive a knee pad insert;
preparing a mold to construct the knee pad insert, the mold having an internal space, an injection channel, and a support member;
placing a gel pad within the internal space to form a portion of the knee pad insert;
injecting foam material through the injection channel into the internal space to form another portion of the knee pad insert; and
integrating the knee pad insert with the selected outer shell.

16. The method of claim 15, further comprising forming an injection foam layer of the knee pad insert, the injection foam layer having two sidewalls.

17. The method of claim 16, further comprising extending a fabric sheet between the two sidewalls of the knee pad insert and covering both the injection foam layer and the gel pad.

18. The method of claim 15, further comprising attaching a molded fabric lamination layer to the outer shell.

19. The method of claim 15, wherein the injected foam material surrounds the gel pad.

20. The method of claim 16, wherein the two sidewalls have heights that depend on an internal width of the molded insert.
